(19) United States
(12) Patent Application Publication
(10) Pub. No.: US 2025/0153192 A1
(43) Pub. Date: May 15, 2025

(54) SEPARATOR

(71) Applicant: GEA WESTFALIA SEPARATOR GROUP GMBH, Oelde (DE)

(72) Inventor: Jürgen MACKEL, Oelde (DE)

(21) Appl. No.: 18/836,214

(22) PCT Filed: Jan. 20, 2023
(86) PCT No.: PCT/EP2023/051397

§ 371 Date: Aug. 6, 2024

(30) Foreign Application Priority Data
Feb. 7, 2022 (DE) 20 2022 100 680.6

(51) Int. Cl. B04B 1/16; B04B 1/08

(52) U.S. Cl. CPC B04B 1/16; B04B 1/08

(57) ABSTRACT

A self-emptying separator includes an emptying mechanism, having a piston valve, which is designed to intermittently open and close the solid emptying openings of the separator. A control arrangement for the emptying mechanism includes a chamber for a fluid and a valve arrangement having at least one valve in communication with the chamber in order to operate the piston valve. As the fluid, the product to be clarified can be fed from a distributor or the separation chamber of the centrifugal drum via a supply channel in the drum to the chamber. The valve is a centrifugal force valve, which closes against a spring force by centrifugal force at the operating speed of the centrifugal drum and is opened by this spring force at a lower speed of the centrifugal drum than the operating speed, or the valve is an electromagnetically actuable valve.

### BACKGROUND AND SUMMARY OF THE INVENTION

Exemplary embodiments of the present invention relate to a self-emptying separator.

In addition to one or more drains for one or more liquid phases, self-emptying separators as defined in this document have an emptying mechanism with a piston valve that is fluid-actuated, in particular with liquid as fluid, and can be moved alternately into an open position and a closed position, whereby the piston valve discontinuously opens solids emptying openings in the drum wall for a certain period of time (open position) and closes them again (closed position). In the open position, a solids phase is discharged from the centrifugal drum. This is not the case in the closed position.

In such emptying mechanisms with a piston valve, the closing liquid used is injected into a closing chamber-usually below the piston valve. The geometry of this closing chamber is selected so that the liquid pressure created by the rotation of the closing liquid and acting on the piston valve is greater than the liquid pressure of the product to be clarified in the separation chamber above the piston valve. This pressure difference causes the piston valve to rise during operation and closes the emptying openings in the drum or closes them again after the solids have been discharged.

By means of a corresponding valve arrangement, such as one or more piston valves, which are in fluid connection with the closing chamber, the closing liquid can be drained from the closing chamber during solids discharge, so that the liquid escapes below the piston valve, which reduces the pressure acting on the piston valve in the closing chamber, so that the liquid pressure exerted on the piston valve by the product above the piston valve moves the piston valve downwards. This releases or opens the emptying openings in the drum.

DE 31 17 807 C1 describes a separator with such an emptying mechanism.

A separator is known from GB 614 501 in which the emptying openings are each equipped with a centrifugal valve that closes the respective openings at operating speed and opens the respective openings at a low drum speed so that a cleaning fluid can flow through. The disadvantage of this design is the tolerance of the spring elements of the individual centrifugal valves. As a result, it is not possible to open all emptying openings absolutely synchronously—as would be necessary with a solids discharge. A non-synchronous opening of the emptying openings would lead to an undesirable drum imbalance during emptying.

DE 196 18 249 also discloses an embodiment in which the drum is equipped with one or more centrifugal valves that close the respective emptying opening at operating speed and open the respective emptying opening at a very low speed so that residual liquid can drain from the drum. However, the valves are not used to empty a solid phase, but to drain residual liquid from the drum at a very low speed. Even in this design, the valves distributed around the circumference are not synchronized so that they are unsuitable for discharging a solid at only slightly reduced speed.

The targeted reduction of the drum speed before emptying is known from DE 10 2017 112 553. Here, a reduction in the speed of the drum serves to reduce wear on the drum or to protect the product to be discharged.

Emptying devices according to the prior art have proven themselves in practice, but they are relatively complex to construct. Exemplary embodiments are directed to reducing this problem.

According to an aspect, a separator, preferably a self-emptying separator, is provided for centrifugally separating a free-flowing product into at least one liquid phase and at least one solid phase, wherein the separator comprises a rotatable centrifugal drum having a vertical axis of rotation, which comprises a separation chamber having a disc stack which comprises solid discharge openings and an emptying mechanism having a piston valve which is designed to close and open the solid emptying openings, wherein a control arrangement is provided for the emptying mechanism, which comprises a chamber for a fluid and a valve arrangement having at least one valve which is in communication with the chamber in order to actuate the piston valve, wherein the product to be clarified, as the fluid, can be fed from a distributor or the separation chamber of the centrifugal drum to the chamber via a supply channel.

In this way, it is advantageously no longer necessary to provide a hydraulic system to feed a separate fluid into the rotating system. This simplifies the design and operation of the separator and makes it more cost-effective.

It is advantageous and simple if the valve is designed as a centrifugal valve that closes by centrifugal force against a spring force at the operating speed of the centrifugal drum and is opened by this spring force at a lower speed of the centrifugal drum than the operating speed, or if the valve is designed as an electromagnetically controllable valve.

If the valve is designed as a centrifugal valve, a valve is created and used that works advantageously without auxiliary energy and without control pulses from an external control system. However, it is also practical and simple if the valve is designed as an electromagnetically controllable valve.

It can be particularly preferably provided that the chamber is designed as a closing chamber and that the piston valve can be raised into a closing position by introducing fluid into the closing chamber and that it can be lowered into an opening position by draining the fluid from the closing chamber.

In this way, it is advantageously no longer necessary to provide and/or store a separate closing and opening fluid and to provide a corresponding hydraulic system to feed it into the rotating system.

According to a preferred variant of the invention, it is provided that the supply channel forms a connecting channel between a distributor channel and the closing chamber. In this way, a connection between the distributor or the separation chamber of the separator downstream thereof and the closing chamber is implemented in a simple manner.

According to a further development of the invention, it is provided that a collar-like baffle plate projects into the distributor channel. This simply ensures by design that the product flowing into the separator after a solids emptying process first fills the closing chamber, so that the separation process can be continued quickly.

According to a further particularly preferred embodiment option of the invention, it is provided that the baffle plate is designed such that it is ensured that the product is diverted from the separation chamber or the distributor into the supply channel to the closing chamber before it flows further into the centrifugal drum after the closing chamber is filled with product and the piston valve is thus in its closed position. This simple design measure ensures that the separation process can continue quickly after an emptying of the solids.

According to a further particularly preferred embodiment option of the invention, the valve is provided to allow the fluid to escape from the closing chamber in order to close the solids emptying openings. This results in a structurally simple option for controlling the solids discharge of the separator, which can be produced with little manufacturing effort.

According to a further particularly preferred embodiment option of the invention, it is provided that the flow conditions in the supply channel into the closing chamber and/or in the outlet from the closing chamber are adjusted by means of nozzles or orifices. In this way, the quantity of emptied solids can be easily adjusted in terms of design and production technology.

Advantageous methods can be implemented with the separator according to the invention. Thus, a method for carrying out a solids discharge in a centrifugal separation of a free-flowing product into at least one solids phase and at least one liquid phase is created with a separator according to the invention, wherein the method can comprise at least the following method steps of:
providing a self-emptying separator configured as described above and providing a free-flowing product or suspension to be processed;
then introducing product into the centrifugal drum rotating at operating speed, wherein part of the product from the separation chamber or the distributor channel enters the closing chamber via the supply channel so that the piston valve is lifted and the solids emptying openings are closed;
then carrying out the separation process until the solids collection chamber in the centrifugal drum is at least partially filled with solids;
then reducing the rotational speed of the centrifugal drum, causing the valve to open, whereby the product escapes from the closing chamber below the piston valve, so that the piston valve is lowered to its open position and the solids emptying openings are cleared, so that the solids phase is discharged from the centrifugal drum; and
then increasing the speed of the centrifugal drum to operating speed, which closes the valve and the piston valve is lifted by the product flowing into the closing chamber, thus closing the solids emptying openings.

### BRIEF DESCRIPTION OF THE SOLE DRAWING FIGURE

In the following, the invention is described in more detail with reference to the drawing by means of an exemplary embodiment. The invention is not limited to this exemplary embodiment, but can also be realized in other ways according to the wording or in other equivalent ways, wherein:

The sole drawing figure shows a full section of a separator according to the invention;

In the following description of the FIGURE, an exemplary embodiment of a separator is described. The individual features of this exemplary embodiment can also be combined with exemplary embodiments not shown and are also suitable in each case as advantageous designs of the objects described in individual or several of the main and sub-claims.

### DETAILED DESCRIPTION

The separator has a rotatable centrifugal drum 1, which can have a vertical axis of rotation D as shown in the sole drawing FIGURE. The centrifugal drum 1 is rotated by a drive motor M, which in this case acts directly on a drive spindle S of the centrifugal drum 1. The drive spindle S is rotatably mounted in a machine frame G. It carries the centrifugal drum 1, which is placed on a free end of the drive spindle S. Alternatively, other drive systems can also be realized, for example an indirect drive of the centrifugal drum 1, wherein a drive motor acts on the drive spindle of the centrifugal drum 1 via a belt drive. A drive system that acts directly on the drum and drives it without a spindle is also feasible.

The centrifugal drum 1 can have a single and/or double conical design (at the bottom and/or top and in particular on the inside). The centrifugal drum 1 can have a lower drum part 2 and an upper drum part 3. These drum parts 2, 3 can be connected to each other in various ways, for example with a locking ring 4. The centrifugal drum 1 also has a product feed pipe 7.

The separator is designed for continuous and not just batchwise operation.

A distributor 5 having at least one distributor channel 51 for feeding product from the product feed pipe 5 into a separation chamber 10 is formed in the centrifugal drum 1. The product is transferred into the rotating system in distributor 5.

The centrifugal drum 1 also has a separation chamber 10 in which the actual centrifugal separation takes place. This has a disc stack 6 consisting of separating discs. It also has a solids collecting chamber 13 radially on the outside, in which the solid phase S separated from the suspension or the free-flowing product P is collected during the separation and/or clarification process.

The centrifugal drum 1 has at least one liquid discharge for a liquid phase L. The centrifugal drum can also have more than one liquid discharge. The liquid discharge is designed here as a paring disc 16. The liquid discharge can also be realized in another way.

The sole FIGURE shows an example of a so-called clarifier separator, which is designed to clarify a product P to be processed in a centrifugal field or to separate a solid phase S and a liquid phase L from it. The separator can also be designed as a so-called separation separator, in which two liquid phases and a solid phase are separated from each other.

An emptying mechanism is used to discharge the solids phase S, which has a piston valve 8 for opening and closing solids emptying openings 9. The solids emptying openings 9 can be distributed around the circumference in the area of the largest diameter of the centrifugal drum 1. The piston valve is vertically movable here.

The emptying mechanism also comprises a control arrangement associated with the piston valve 8 for controlling its opening and closing movements.

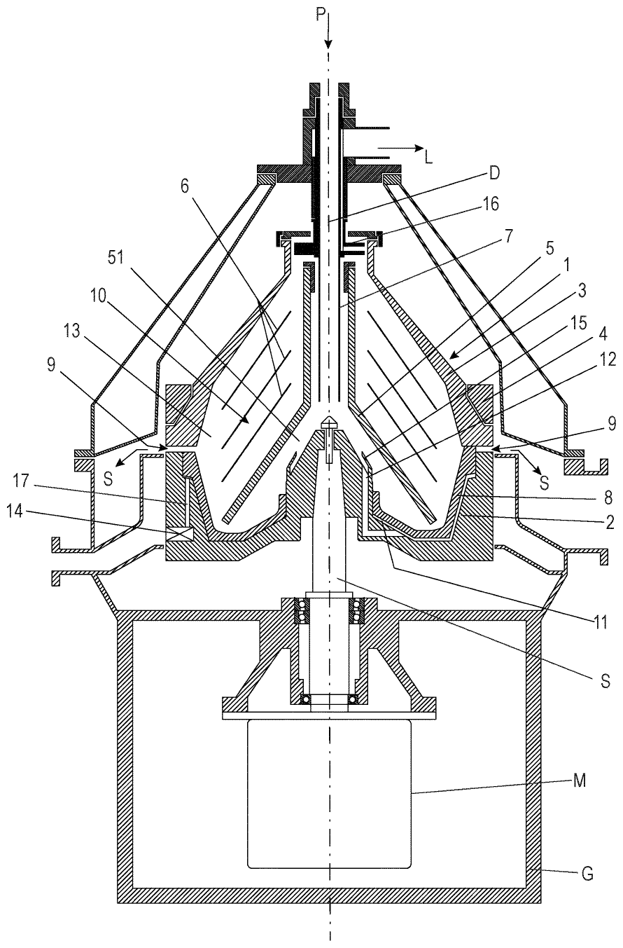

The left half of the centrifuge in FIG. 1 shows the piston valve 8 in a lowered opening position, while the right half of the centrifuge shows the piston valve 8 in a raised closing position.

The control arrangement can have a control unit not shown here or be connected to it. A higher-level control unit of the centrifuge can also be used as this control unit.

The control arrangement here also comprises a closing chamber 11 for fluid.

This closing chamber 11 is designed in such a way that the closing movement of the piston valve 8 can be initiated by introducing fluid and in such a way that a closed position of the piston valve 8 can be maintained during rotation at an operating speed for centrifugal processing.

The fluid can be drained from the closing chamber 11 by a valve arrangement, which can comprise one or more valves 14, which are connected to the closing chamber 11.

The fluid used in the separators according to the invention is the product P to be clarified, which is filled into the centrifugal drum 1 via the feed pipe 7 and can be fed from the distributor 5 or the separation chamber 10 into the closing chamber 11.

To implement this, at least one connecting channel in the form of a supply channel 12 can be formed between a separation chamber 10 of the centrifugal drum 1 or the distributor 5 and the closing chamber 11. In order to lift the piston valve 8—i.e., to close the solids emptying openings 9—the connecting channel 12 is used as a supply channel to fill the closing chamber. Two or more of the connecting channels can also be provided, e.g., distributed around the circumference.

As soon as the free-flowing product P to be processed centrifugally enters the distributor 5 and is fed into the centrifugal drum 1 rotating at operating speed, it passes-according to the sole drawing FIGURE-already in the distributor 5 through the supply channel 12 directly into the closing chamber 11, builds up pressure in the closing chamber due to the rotation of the centrifugal drum 1, thereby lifting the piston valve 8 and thus closing the solids emptying openings 9 of the centrifugal drum 1. The separation process can now be continued in the known manner until the solids collecting chamber 13 in the centrifugal drum 1 is filled at least partially or completely with solids S.

The valve arrangement with at least one valve 14 is used to empty the solids collecting chamber 13.

According to an advantageous—but not mandatory-variant, the valve 14 can advantageously be designed as a centrifugal valve, which closes at the operating speed of the centrifugal drum 1 by centrifugal force against a spring force and is opened by this spring force-which is then greater than the centrifugal force acting on the valve 14—at a lower speed of the centrifugal drum 1 than the operating speed.

If the speed of the centrifugal drum 1 is now reduced during operation with the control device to a value at which the valve 14 opens, the fluid for closing the solids emptying openings 9 escapes from the rotating system under the piston valve 8 through a drain channel 17 and the valve 14. This lowers the piston valve 8 to its open position and releases the solids emptying openings 9 so that the solids phase S can escape from the centrifugal drum 1.

If the speed of the centrifugal drum 1 is then increased again, the valve 14 closes due to the increased centrifugal force and the product P flows back into the closing chamber 11. This causes the piston valve 8 to lift back into its closed position and closes the solids emptying openings 9. The time at which the speed is reduced and lowered and the time at which the speed is subsequently increased and raised can be determined and initiated by the control unit mentioned above. The control unit also contains the motor control required for speed control.

If the product feed 7 remains open during such a solids emptying process, product P constantly flows into the open closing chamber 11. As the centrifugal valve is open, the closing pressure in the closing chamber cannot be built up so that the piston valve is completely lifted.

The volume of fluid remaining in the closing chamber 11 depends on the selected cross-sections of the supply channel 12 and the drain channel 17 of the closing chamber 11. By suitably determining these cross-sections and the duration of emptying, it can be achieved that not the entire volume of solids is emptied from the centrifugal drum 1, but only part of it. The flow conditions in the supply channel 12, into the closing chamber 11 and/or in the drain channel 17 from the closing chamber 11 in the direction of the at least one valve 14 can be adjusted and optimized using nozzles or orifices depending on the respective requirements.

As soon as the centrifugal drum 1 is accelerated again after a solids discharge process and the valve 14 closes as described, the product flowing into the closing chamber 11 also raises the piston valve 8 again and closes the solids emptying openings 9.

If the product feed 7 is not kept open during a solids emptying process, but is instead closed, no further product P flows into the closing chamber 11, so that it empties completely and the lowering piston valve 8 opens the solids emptying openings 9 completely. The solids emptying openings 9 can only be closed again when the speed of the centrifugal drum 1 is increased again and the product feed 7 is opened so that fluid can enter the closing chamber 11.

In order to ensure that the product P flowing into the centrifugal drum 1 flows from the separation chamber 10 or the distributor 5 directly into the supply channel 12 to the closing chamber 11, a collar-like deflector plate 15 can optionally be provided, which projects into the distributor channel 51. This can extend in sections parallel to the main direction of extension of the distributor channel 51 of the distributor in which the supply channel 12 is located.

The deflector plate 15 is preferably arranged and designed in such a way that it is ensured that the product P from the separation chamber 10 or the distributor 5 is immediately diverted into the supply channel 12 to the closing chamber 11 during or after emptying, before further product-if the closing chamber 11 is filled accordingly and the solids emptying openings 9 are closed by a closing movement of the piston valve 8 initiated by this-flows further into the centrifugal drum 1.

Alternatively, as discussed above, the valve 14 can also be designed in a different way, for example as a valve that works according to a different operating principle, such as a solenoid valve that can be opened and closed by control pulses. This control pulse could, for example, be sent by radio into the rotating system to a receiver on the solenoid valve (not shown). The electrical energy required for this can, for example, be transmitted to the rotating drum by means of a system that works on the inductive principle. However, an energy storage device, such as a battery, can also be provided in the drum.

### LIST OF REFERENCE SIGNS

1 Centrifugal drum
2 Lower drum part
3 Upper drum part
4 Locking ring
5 Distributor
51 Distributor channel
6 Disc stack
7 Product feed
8 Piston valve
9 Solids emptying opening
10 Separation chamber
11 Closing chamber
12 Supply channel
13 Solids collection chamber
14 Valve
15 Baffle plate
16 Paring disc
17 Drain channel
D Axis of rotation
S Solid
L Liquid phase
P Product
M Drive motor
S Drive spindle
G Machine frame

1-9. (canceled)

10. A self-emptying separator for centrifugally separating a free-flowing product into at least one liquid phase and at least one solids phase, wherein the self-emptying separator comprises:
a rotatable centrifugal drum having a vertical axis of rotation and comprising
a separation chamber in which a disc stack is arranged,
a solids emptying openings;
an emptying mechanism, which has a piston valve, is configured to open and close the solids emptying openings discontinuously; and
a control arrangement configured to control the emptying mechanism, wherein the control arrangement comprises a control chamber for a fluid and a valve arrangement having at least one valve in communication with the control chamber to actuate the piston valve
wherein the self-emptying separator is configured so that the fluid, which is the free-flowing product, is fed from a distributor or the separation chamber of the centrifugal drum to the separation chamber via a supply channel in the drum,
wherein the at least one valve is
a centrifugal valve configured to close by centrifugal force against a spring force at an operating speed of the centrifugal drum and to open by the spring force at a lower speed of the centrifugal drum than the operating speed, or
an electromagnetically controllable valve.

11. The self-emptying separator of claim 10, wherein the control chamber is a closing chamber, the piston valve is raisable into a closing position by introducing fluid into the closing chamber, and the piston valve is lowerable into an opening position by draining the fluid from the closing chamber.

12. The self-emptying separator of claim 11, wherein the supply channel is a connecting channel between a distributor channel of the distributor and the closing chamber.

13. The self-emptying separator of claim 12, wherein a deflecting device projects into the distributor channel, wherein the deflecting device is a collar-like baffle plate.

14. The self-emptying separator of claim 11, wherein the at least one valve is configured to allow the fluid to escape from the closing chamber to open the solids emptying openings.

15. The self-emptying separator of claim 10, wherein the at least one valve is a centrifugal valve.

16. The self-emptying separator of claim 10, wherein the at least one valve, which is a centrifugal valve, is configured to close by centrifugal force against a spring force at the operating speed of the centrifugal drum and is opened by the spring force at a lower speed of the centrifugal drum than the operating speed.

17. The self-emptying separator of claim 10, wherein the at least one valve is the electromagnetically controllable valve.

18. The self-emptying separator of claim 11, further comprising:
nozzles or orifices configured to adjust flow conditions in the supply channel into the closing chamber or in an outlet from the closing chamber.
